(19) United States
(12) Patent Application Publication
(10) Pub. No.: US 2011/0011353 A1
(43) Pub. Date: Jan. 20, 2011

(54) Pet Restraint

(76) Inventor: Chad Stokes, Council Bluffs, IA (US)

Correspondence Address: STINSON MORRISON HECKER LLP;ATTN: PATENT GROUP, 1201 WALNUT STREET, SUITE 2900, KANSAS CITY, MO, 64106-2150, US

(21) Appl. No.: 12/502,766

(22) Filed: Jul. 14, 2009

(51) Int. Cl. A01K 15/04; A01K 27/00

(52) U.S. Cl. 119/833; 119/856

(57) ABSTRACT

A pet restraint comprising an elongated bite member adapted to be placed in a pet's mouth and a collar attachment member having a clip, notch or opening adapted to receive a pet collar at a posterior portion of said pet's neck.

### CROSS-REFERENCE TO RELATED APPLICATIONS

Not applicable

### STATEMENT REGARDING FEDERALLY SPONSORED RESEARCH OR DEVELOPMENT

Not applicable.

### BACKGROUND OF THE INVENTION

The present invention concerns pet restraints, and in particular, those pet restraints used to prevent dogs from biting.

### DESCRIPTION OF RELATED ART

There are many devices available to prevent pets, especially large dogs, from biting. The most common is a muzzle, usually made from leather in the form of a halter or harness. The muzzle is fitted over the dog's mouth and a strap fits around the back of the dog's head. Often there is a strap that fits around the dog's neck. The muzzle can also be harmful to the dog, perhaps preventing it from panting on a hot day.

Further, there are various pet collars known in the art. These collars typically form a loop around the pet's neck. Often they are made of a material that the pet may be able to bite through, especially if the loop is not tight enough.

Thus, it would be desirable to provide a pet restraint that keeps a dog from unwanted hard biting, and a pet restraint that is difficult for the pet to escape from.

### BRIEF SUMMARY OF THE INVENTION

The present invention is directed to a novel pet restraint and a pet restraint system comprising a conventional collar and the pet restraint. Further, methods of restraining a pet or other animal are provided. In general, the pet restraint comprises (1) an elongated bite member adapted to be placed in a pet's mouth, and (2) a collar attachment member connected to the elongated bite member to form a loop comprised of the elongated bite member around the pet's neck and mouth. The collar attachment member has a collar fastening means (such as a clip, notch, or opening) adapted to receive a pet collar at a posterior portion of the pet's neck. In the preferred embodiment, the elongated bite member and the collar cross each other, thereby stabilizing the position of the pet restraint.

In one aspect, the collar attachment member is connected to the elongated bite member at a distance of 1 cm to 10 cm, most preferably 2 cm to 6 cm, from the collar fastening means adapted to received the pet collar.

In another aspect, where more flexibility of the pet restraint is desired, one or more elongated elastic members are connected to the elongated bite member. Thus, an elongated elastic member may be used to connect the first end of the elongated bite member to the collar attachment member. The elongated elastic member may also connect the second end of the elongated the bite member to the collar attachment member. The loop formed from the elongated bite member and the elongated elastic member(s) is placed in the pet's mouth and around the pet's neck.

In another aspect, the collar attachment member has a first animal contact side and a second animal non-contact side. One or more openings extend through the collar attachment member from the first animal contact side to the second animal non-contact side. These openings can be used to receive the elongated elastic member and/or elongated bite member such that a portion of the elongated elastic member and/or elongated bite member is positioned on the animal contact side. The elastic member and/or bite member is adapted to be pulled through the opening(s), thereby adjusting a circumference of the loop depending on said pet's head and neck size. The elongated elastic member and/or elongated bite member may be tied or clamped such that said loop is adjusted to a desired length.

In one aspect, the elongated bite member can be detached from the elongated elastic member(s) so that the elongated bite member may be used as a stand-alone chew toy. A preferred elongated bite member comprises a hollow rubber hose having a rope threaded through the interior thereof. The rope is also preferably wrapped around the exterior of the rubber hose so that the pet's teeth engage the rope when the elongated bite member is placed in the pet's mouth.

The pet restraint is used with a standard pet collar, which is typically a nylon strap with a buckle or other fastener at one end. To use the system, the elongated bite member of the pet restraint is placed in the pet's mouth. The collar attachment member of the pet restraint is positioned at the posterior portion of the pet's neck. The pet collar is placed around the pet's neck and engages the collar fastening means the collar attachment member to hold the attachment member in a fixed position. The loop formed by the elongated bite member and/or elongated elastic member(s) is then tightened to form a loop around the pet's mouth and neck so as to make the loop more secure. Because the pet collar and loop formed of the elongated bite member and/or elongated elastic member(s) cross each other, the pet restraint is further stabilized in the pet's mouth.

In yet another aspect, the pet restraint is well adapted to prevent the pet from chewing its collar into pieces, thereby escaping from the pet owner or from a tie-down area.

In one aspect, the present invention is directed to a pet restraint that prevents the animal from biting but allows an animal to breathe naturally while the pet restraint is secured about the animal's head.

In another aspect, the pet restraint of the present invention is adjustable so that the restraint may be comfortably fitted to the mouth, neck, and head so that the animal will be unable to bite.

In still another aspect, the pet restraint of the present invention is configured and constructed so that, when securely fastened about the animal's head, it allows the near natural movement of the animal's mouth to thereby facilitate a normal breathing pattern and, at the same time, protects the animal's handler from being bitten.

While the pet restraint of the present invention is contemplated to be most often used with dogs, but it should be recognized that the inventive restraint can be adapted, as and if necessary, for use on any animal having a generally elongated snout.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1A illustrates the pet restraint in accordance with a first embodiment of the present invention. The pet restraint is illustrated for use with a dog, along with a conventional collar.

FIG. 1B illustrates a pet restraint in accordance with a second embodiment of the present invention. The pet restraint is illustrated for use with a dog, along with a conventional collar.

FIG. 2 illustrates the pet restraint shown in FIG. 1B in more detail.

FIG. 3A illustrates a first embodiment for connecting one end of the elongated bite member with one or more elongated elastic members using a knot in the elongated bite member. It will be appreciated that each end of the elongated bite member can be attached to an elongated elastic member in a like manner.

FIG. 3B illustrates a second embodiment for connecting the elongated bite member with one or more elongated elastic members using a connecting screw. It will be appreciated that each end of the elongated bite member can be attached to an elongated elastic member in a like manner.

FIG. 4A illustrates the collar attachment member in accordance with the first embodiment of pet restraint shown in FIG. 1A.

FIG. 4B illustrates the collar attachment member in accordance with the second embodiment of pet restraint shown in FIG. 1B.

FIG. 4C illustrates the collar attachment member in accordance with a third embodiment of pet restraint of the present invention.

### DETAILED DESCRIPTION OF PREFERRED EMBODIMENT

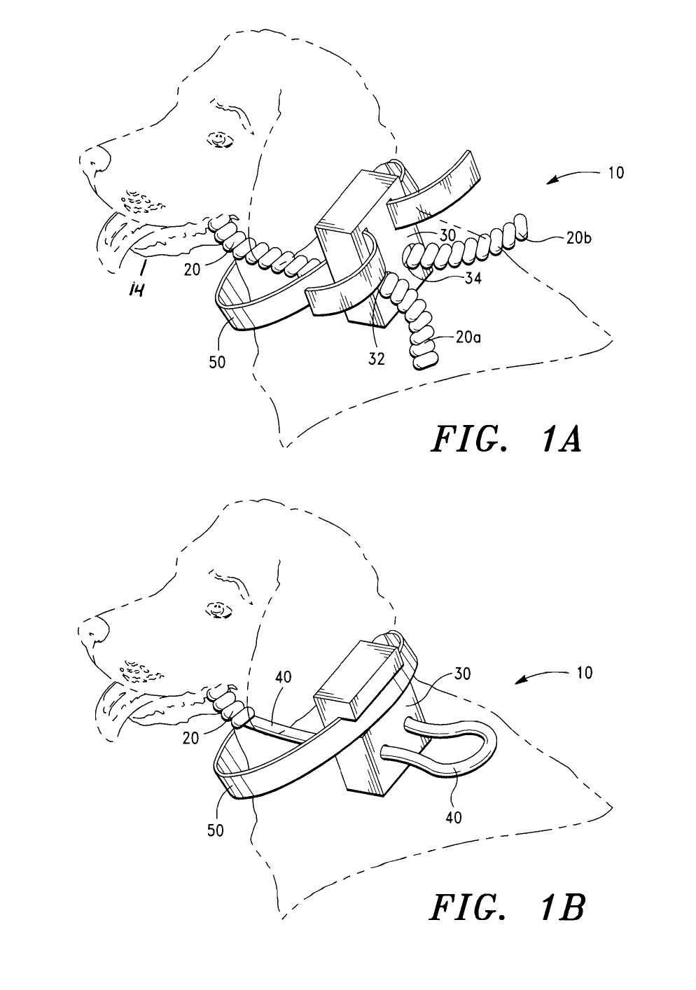

With initial reference to FIGS. 1A and 1B, there is shown a pet restraint 10 constructed in accordance with the teachings of the present invention and disposed in operative position about an animal's head 12, the animal depicted being a dog. While the pet restraint 10 is shown for illustrative purposes on a dog's head, it will be recognized that the pet restraint may be effectively utilized on any animal having a generally elongated jaw and nose, otherwise commonly referred to as the animal's snout.

The pet restraint 10 comprises an elongated bite member 20 adapted to be placed in a pet's mouth 14. In FIG. 1A, the elongated bite member 20 is connected to a collar attachment member 30 In FIG. 1B, the elongated bite member 20 of the pet restraint 10 is connected to the collar attachment member 30 by one or more elongated elastic members 40 which facilitate adjustment of the pet restraint 10 to fit the size of the pet's neck and head. The elongated bite member 20 is adapted to be placed in the mouth of the pet such that the pet bites down on the elongated bite member 20. The elongated bite member 20 is thus comprised of a sturdy material that a typical pet cannot bite or chew through. Preferably, the elongated bite member comprises a flexible material, such as a hollow rubber hose, but one or more portions thereof may be formed of metal or hard plastic that are resistant to breaking or tearing from a bite, especially in the portions of the elongated bite member 20 where it is anticipated that the pet's teeth will engage the elongated bite member 20.

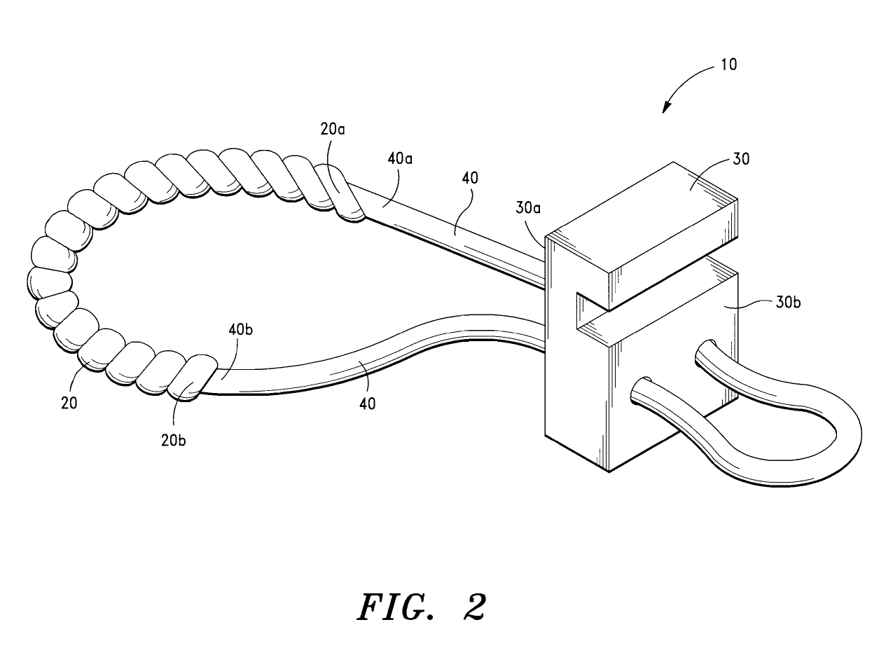

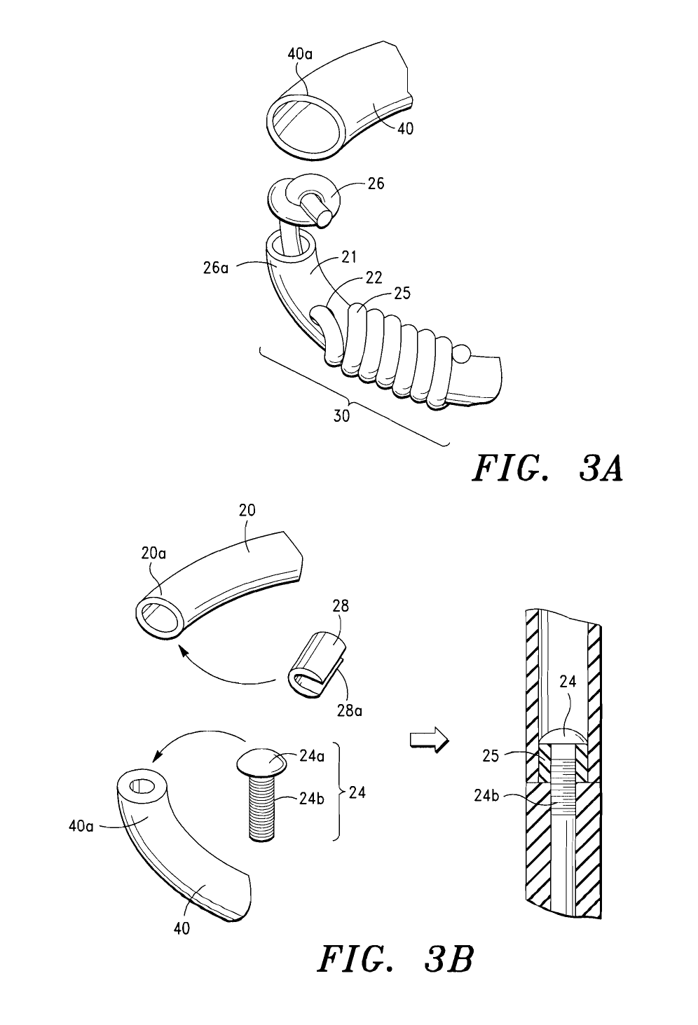

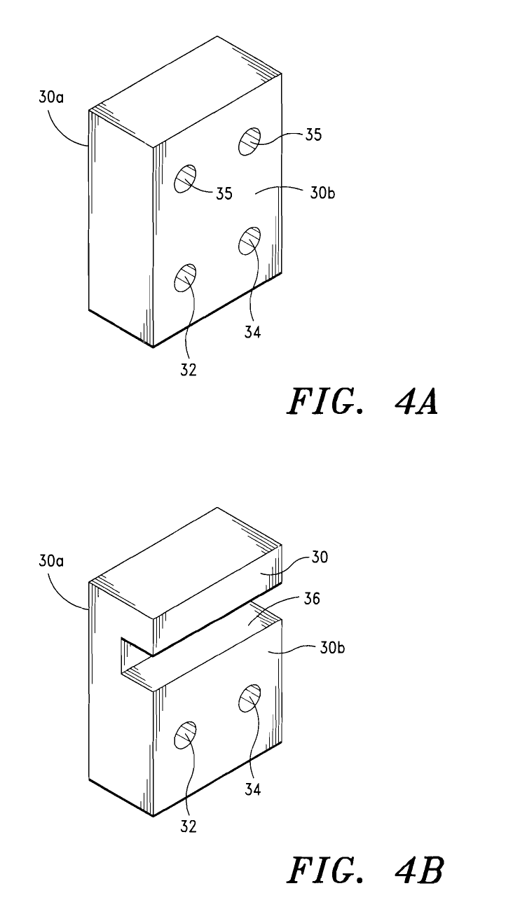

In a preferred aspect, the elongated bite member comprises a hollow rubber hose 21 having a rope 25 threaded through the interior of the rubber hose 21. Construction of a portion of the elongated bite member is illustrated in FIG. 3A. A hole 22 is made at each end of the hollow rubber hose, and the rope 25 is wrapped around the exterior of the rubber hose. The rope is preferably a continuous piece of rope, but may be comprised of one or more pieces tied or otherwise connected together. Further, the rope is preferably wrapped around the exterior of the rubber hose 21 along substantially all of its entire length as generally shown in FIGS. 1A, 1B, and 2.

The collar attachment member 30 is adapted to be placed on the posterior neck region of the animal. The collar attachment member 30 includes a first animal contact side 30a which generally faces and contacts the animal and a second non-contact side 30b, which generally faces away from the animal. The collar attachment member 30 is preferably comprised of a hard material, such as plastic, wood, or foam rubber material. The collar attachment material may be optionally impregnated with or contain a reservoir/cavity holding one or more therapeutic agents, such as insecticides for controlling fleas and ticks. Such materials are typically those used in insecticidal collars comprising a solid matrix material impregnated with an insecticidal composition that is released from the collar and spread when the collar rubs against the animal's coat. Suitable insecticides include chlorinated hydrocarbons, organophosphates, pyrethrins, pyrethroids, and carbamates. Non-limiting examples of such insecticides are those identified by the common names lindane, methoxychlor, permethrin, cypermethrin, dichlorvos, diazinon, chlorfenvinphos, bendiocarb, amitraz, chlorpyrifos, deltamethrin, and sevin. In a preferred embodiment, the active ingredient is a pyrethroid, which class of insecticides is particularly well-suited for the treatment of fleas and ticks. Suitable insect repellents include DEET, citronella, permethrin, pyrethrin, among others. Suitable insect growth repellents include methoprene, hydroprene, S-methoprene, S-hydroprene, dimilin (diflupenzeron), and chromazine, among others. These and other insecticides, insect repellants, and IGRs, as known in the art, can be used alone or in combination as active ingredients in the gel of the present invention. The therapeutic agent may be an endectocide such as doramectin, ivermectin, avermectin, or moxidectin, among others, which are commercially available.

The collar attachment member 30 may be directly connected to the elongated bite member 20 (FIG. 1A) or may be indirectly connected to the elongated bite member 20 via one or more elongated elastic member(s) 40 (FIG. 1B, FIG. 2). Any suitable connection device may be used, for example, buckles, latches, quick connect assemblies, or simply tying the members together. The elongated bite member 20 is preferably removably connected to the elongated elastic member(s) 40 so that the elongated bite member 20 can be removed and used as a stand-alone chew toy. Alternatively, the elongated bite member 20 may be permanently connected to the elongated elastic member(s) 40.

FIG. 3A illustrates an exemplary embodiment for connecting an end 20a of the elongated bite member 20 to an end 40a of the elongated elastic member 40. In FIG. 3A, the rope 25 of the elongated bite member 20 has a knot 26 at each end. The knot 26 has a diameter that is larger than the interior diameter of the elongated elastic member 40 so that when the knot is placed inside the elongated elastic member 40, it cannot be removed without significant force. Further, because the connection remains relatively smooth on the exterior surface (compared to a buckle, for example), the animal has no protuberance to grab onto with the animal's paws if the animal tries to remove the pet restraint at the connecting location.

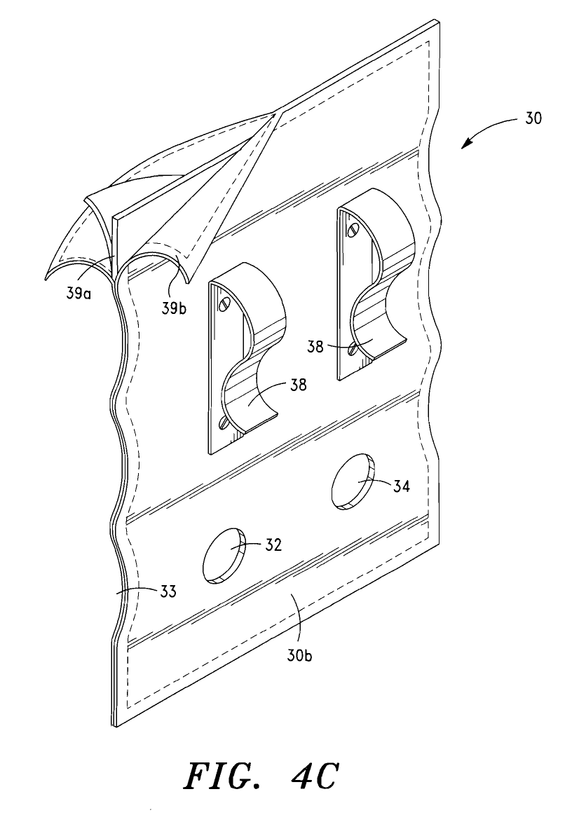

FIG. 3B illustrates another exemplary embodiment for connecting an end 20a of the elongated bite member 20 to an end 40a of the elongated elastic member 40. As shown in FIG. 4, a stopper 28 having a slit 28a is placed into the end 20a of the elongated bite member 20, thereby narrowing the inner diameter of the elongated bite member 20. The interior of the elongated elastic member 40 engages threads on the tail 24b of a fastening screw 24. The diameter of the tail 24b of fastening screw is larger than the inner diameter of the elongated elastic member 40 so that the screw 24 and elongated elastic member 40 cannot be pulled apart without significant force (if at all). The fastening screw 24 is forced through the stopper so that the head 24a of the fastening screw 24 lies over the stopper while a portion of the tail 24b of the fastening screw 40 extends through the stopper 28. The fastening screw 24 thus tightly engages the elongated bite member 20 via the stopper. In another example (not shown), the elongated elastic member 40 is threaded or otherwise placed in the interior of hose 21 of the elongated bite member 20 and extends from each end 21.

A first exemplary collar attachment member is illustrated in FIGS. 1A and 4A. In this embodiment, the collar attachment member 30 preferably includes one or more openings 32, 34 for receiving the elongated bite member 20 or the elongated elastic member(s) 40. More specifically, as shown in FIG. 1A, the elongated bite member 20 is has a first end 20a that is inserted through opening 32, preferably from the animal contact side 30a to the animal non-contact side 30b of the collar attachment member 30. The second end 20b of the elongated bite member 20 is inserted through opening 34, preferably from the animal contact side 30a to the animal non-contact side 30b of the collar attachment member 30. The ends 20a-b of the elongated bite member may be tied together, knotted, clamped, latched, or otherwise connected together or to the collar attachment member 30 (not shown). In this embodiment, the elongated bite member 20 forms a loop adapted to be placed in the pet's mouth and around the pet's neck. The circumference of the loop may be adjusted in any number of ways, e.g., tied, clamped, knotted, or otherwise shortened.

As shown in FIG. 4A, the collar attachment member 30 has one or more openings 35 adapted to receive a pet collar on the second animal non-contact side 30b. Thus, during use, the pet collar acts 50 to stabilize the pet restraint 10 (FIG. 1A). The openings 35 are preferably positioned at a distance of 1 cm to 10 cm from the point at which the elongated bite member 20 and/or elongated elastic member 40 are connected to the collar attachment member 30. Typically, the elongated bite member 20 and/or elongated elastic member 40 is positioned about 2 cm to 6 cm below the openings 35.

A second exemplary collar attachment member is illustrated in FIG. 1B and 4B. In this embodiment, the collar attachment member 30 includes one or more openings 32, 34 for receiving the elongated bite member 20 or the elongated elastic member(s) 40. More specifically, as shown in FIG. 1B (and in more detail in FIG. 2), the elongated bite member 20 has a first end 20a connected to a first end 40a of the elongated elastic member 40. The second end 40b of the elongated elastic member is inserted through opening 32, preferably from the first animal contact side 30a to the second animal non-contact side 30b of the collar attachment member 30, and then back through opening 34 from the second animal non-contact side 30b to the first animal contact side 30a of the collar attachment member 30. The elongated bite member 20 has a second end 20b, which is connected to the second end 40b of the elongated elastic member 40. Together the elongated elastic member 40 and the elongated bite member 20 form a loop adapted to be placed in the pet's mouth and around the pet's neck. As shown in FIG. 4B, the collar attachment member 30 has a notch 36 adapted to receive a pet collar on the second animal non-contact side 30b. Thus, during use, the pet collar acts 50 to stabilize the pet restraint 10. The notch 36 is preferably positioned at a distance of 1 cm to 10 cm from the point at which the elongated bite member 20 and/or elongated elastic member 40 are connected to the collar attachment member 30. Typically, the openings 32, 34 are about 2 cm to 6 cm from the notch 36.

FIG. 4C illustrates an alternative collar attachment member 30 having one or more clips 38 adapted to receive a pet collar on the second animal non-contact side 30b. Further, in this embodiment, the collar attachment member 30 comprises one or more blocks of foam rubber 39a impregnated with a therapeutic agent for controlling fleas and ticks with one or more optional sheets of synthetic material 39b, such as polyester, overlying the foam rubber layer 39a. In addition, the collar attachment member 30 includes on or more thumb or finger ridges 33 adapted to receive the thumb and/or fingers of the user to facilitate placement or removal of the pet restraint on the pet. It will be appreciated that the collar attachment member of FIG. 4C could be used with the elongated bite member 20 and optional elongated elastic member(s) 30 as shown in the prior figures.

As shown in FIGS. 1A and 1B, the elongated bite member 20 and optional elongated elastic member(s) 40 preferably are positioned on the collar attachment member 30 so that they form a cross with the collar used with the animal. This crossing provides additional stability to the overall pet restraint device.

From the foregoing it will be seen that this invention is one well adapted to attain all ends and objectives herein-above set forth, together with the other advantages which are obvious and which are inherent to the invention. Since many possible embodiments may be made of the invention without departing from the scope thereof, it is to be understood that all matters herein set forth or shown in the accompanying drawings are to be interpreted as illustrative, and not in a limiting sense. While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A pet restraint comprising:
an elongated bite member adapted to be placed in a pet's mouth, said elongated bite member having a first end and a second end;
a collar attachment member connected to said elongated bite member to form a loop comprising said elongated bite member, said collar attachment member having a collar fastening means adapted to receive a pet collar at a posterior portion of said pet's neck.

2. The pet restraint of claim 1 wherein said collar attachment member is connected to said elongated bite member at a distance of 1 cm to 10 cm from said collar fastening means.

3. The pet restraint of claim 2 wherein said distance is 2 cm to 6 cm.

4. The pet restraint of claim 1 further comprising an elongated elastic member, wherein said elongated elastic member connects said first end of said elongated bite member to said collar attachment member.

5. The pet restraint of claim 4 wherein said elastic member connects said second end of said elongated bite member to said collar attachment member.

6. The pet restraint of claim 1 further comprising an elongated elastic member, said elongated elastic member having a first and second end; said first end of said elongated elastic member being connected to said first end of said elongated bite member, and said second end of said elongated elastic member being connected to said second end of said elongated bite member; said loop comprising said elongated bite member and said elongated elastic member, and
wherein said elongated elastic member connects said collar attachment member to said elongated bite member.

7. The pet restraint of claim 6 wherein said collar attachment member has a first animal contact side and a second animal non-contact side, and wherein said collar attachment member at least one opening that extends through said collar attachment member from said first animal contact side to said second animal non-contact side; and wherein said opening receives said elongated elastic member such that a portion of said elongated elastic member is positioned on said first animal contact side and a portion of said elongated elastic member is positioned on said second animal non-contact side.

8. The pet restraint of claim 7 wherein said elastic member is adapted to be pulled through said at least one opening, thereby adjusting a circumference of said loop depending on said pet's head and neck size.

9. The pet restraint of claim 8 wherein said portion of said elongated elastic member positioned on said second animal non-contact side of said collar attachment member is tied or clamped such that said loop circumference is adjusted to a fixed length.

10. The pet restraint of claim 6 wherein said collar attachment member has a first animal contact side and a second animal non-contact side, and wherein said collar attachment member a first opening and a second opening, said first and second openings extending through said collar attachment member from said first animal contact side to said second animal non-contact side; and wherein said first and second openings receive said elongated elastic member so that a portion of said elongated elastic member is positioned on said first animal contact side and portion of said elongated elastic member is positioned on said second animal non-contact side.

11. The pet restraint of claim 10 wherein said elastic member is adapted to be pulled through said first and second openings, thereby adjusting said loop depending on said pet's head and neck size.

12. The pet restraint of claim 1 wherein said elongated bite member comprises a hollow flexible rubber material.

13. The pet restraint of claim 12 wherein said elongated bite member has a rope extending through said hollow flexible rubber material.

14. The pet restraint of claim 13 wherein said rope is also wrapped around an exterior surface of said flexible rubber material.

15. The pet restraint of claim 1 wherein said collar attachment member comprises foam rubber.

16. The pet restraint of claim 1 wherein said collar attachment member is shaped to have one or more finger ridges adapted to receive a user's finger.

17. A pet restraint system comprising:
the pet restraint of claim 1; and
a pet collar.

18. A pet restraint comprising:
an elongated bite member adapted to be placed in a pet's mouth, said elongated bite member having a first end and a second end;
an elongated elastic member, said elongated elastic member having a first end and a second end; said first end of said elongated elastic member being connected to said first end of said elongated bite member, and said second end of said elongated elastic member being connected to said second end of said elongated bite member, thereby forming a loop adapted to placed in said pet's mouth and around said pet's neck, said loop comprising said elongated bite member and said elongated elastic member, and
a collar attachment member connected to said elongated elastic member, said collar attachment member having a first animal contact side and a second animal non-contact side, said collar attachment member having a notch adapted to receive a pet collar on said second animal non-contact side; said collar attachment member having at least one opening that extends through said collar attachment member from said first animal contact side to said second animal non-contact side; and wherein said at least one opening receives said elongated elastic member such that a portion of said elongated elastic member is positioned on said first animal contact side and a portion of said elongated elastic member is positioned on said second animal non-contact side.

19. The pet restraint of claim 18 wherein said portion of said elongated elastic member positioned on said second animal non-contact side of said collar attachment member is tied or clamped such that said loop is adjusted to a fixed length.

20. The pet restraint of claim 1 8 wherein said at least one opening in said collar attachment member is spaced at a distance of 1 cm to 10 cm from said notch.

21. The pet restraint of claim 18 wherein said elongated elastic member comprises two or more elastic segments connected together.

22. The pet restraint of claim 18 wherein said collar attachment member is impregnated with a therapeutic agent or has a reservoir containing a therapeutic agent.

23. A method for restraining a pet using the pet restraint of claim 1 comprising:
placing the elongated bite member of the pet restraint in said pet's mouth;
placing the collar attachment member at a posterior portion of said pet's neck;
fastening a pet collar around a pet's neck and to said collar fastening means of said collar attachment member.

24. The method of claim 23 further comprising the step of tightening said loop around said pet's mouth and neck so as to make the loop more secure.

25. The method of claim 24 wherein said tightening comprises the step of tying a knot in said elongated bite member.

26. The method of claim 23 wherein said pet collar and said elongated bite member cross each other when placed on said pet's neck.
